(19) United States
(12) Patent Application Publication
(10) Pub. No.: US 2025/0353028 A1
(43) Pub. Date: Nov. 20, 2025

(54) FOLDABLE MARKING DEVICE

(71) Applicant: Weidong LI, Xinji City (CN)

(72) Inventor: Weidong LI, Xinji City (CN)

(73) Assignee: HEBEI SNDAS SURVEY AND DRAW CO., LTD., Xingtai City (CN)

(21) Appl. No.: 19/281,664

(22) Filed: Jul. 27, 2025

(51) Int. Cl. B05B 12/30

(52) U.S. Cl. CPC B05B 12/30

(57) ABSTRACT

The invention discloses a foldable marker, which includes a base, a connecting tube, a handle, and a connecting cord. The base has an installation position and an output component. The connecting tube consists of upper and lower sections. The lower section is connected to the base, while the upper section has an upper connector and the lower section has a lower connector. The upper connector is connected to the lower connector and can rotate between a folded position and a use position. The handle is connected to the connecting tube and has an operating component. The connecting cord connects the operating component and the output component. When the operating component is pressed by the user, it drives the connecting cord and the output component to move, thereby pressing the nozzle of the spray can.

### TECHNICAL FIELD

The present invention relates to the field of road technology, and more particularly, to a foldable marking device.

### BACKGROUND OF THE INVENTION

As a road construction device used to draw various regulatory, guiding, and warning marks on flat surfaces, the marking device is widely applied in roads, highways, parking lots, squares, runways, and other venues. With its advantages of speed, efficiency, and accuracy, the marking device has played a significant role in urban planning and highway construction, maximizing the reduction of construction time and economic investment for road works.

At present, existing marking devices on the market vary in size. For instance, marking vehicles, which can spray paint to form regulatory marks while moving, are relatively large in volume. On the other hand, there are smaller, handheld marking devices that allow users to draw regulatory marks on flat surfaces while walking. However, these handheld marking devices are usually long to enable users to draw marks without bending over, which makes them inconvenient to carry.

To address the above-mentioned issues, the present invention provides a foldable marking device. It features a simple structure, convenient use, small size, and easy storage.

### SUMMARY OF THE INVENTION

To overcome the deficiencies of the existing technology, the present invention provides a foldable marking device that features a simple structure, convenient use, small size, and easy storage.

The technical solution adopted by the present invention to solve its technical problem is as follows:

A foldable marking device, comprising:
A base having an installation position and an output component provided thereon, the installation position being configured to allow a spray can to be installed, and the output component being configured to press the nozzle of the spray can to release paint;
A connecting tube including an upper tube section and a lower tube section, the lower end of the lower tube section being connected to the base, the lower end of the upper tube section having an upper connector, the upper end of the lower tube section having a lower connector, the upper connector being connected to the lower connector and being rotatable between a folded position and a usage position;
A handle connected to the upper end of the connecting tube, the handle having an operating component for user pressing;
A connecting cord with its upper end connected to the operating component and its lower end connected to the output component, when the operating component is pressed by the user, the operating component drives the output component to move via the connecting cord, thereby causing the output component to press the nozzle of the spray can.

The beneficial effects of the present invention are as follows: With the above structure, when storing or transporting the product, the upper connector is rotated to the folded position, where the upper tube section and the lower tube section are placed side by side, and the flexible connecting cord bends at the connection between the upper connector and the lower connector. This significantly reduces the length of the product, making it convenient for users to store and transport. When using the product, the upper connector is rotated to the usage position, where the upper tube section and the lower tube section are connected end-to-end to form the connecting tube. This allows users to hold the handle and control the movement of the base located at the lower end of the connecting tube via the connecting tube. While moving the base, users can press the operating component, which in turn drives the connecting cord and the output component connected to the connecting cord. The output component then presses the nozzle of the spray can, allowing paint to be sprayed out to form a marking line. The device is easy to use.

### BRIEF DESCRIPTION OF DRAWINGS

In order to more clearly illustrate the technical solutions in the embodiments of the present invention, a brief introduction to the drawings used in the description of the embodiments is provided below. The drawings described below are merely some embodiments of the present invention. For those of ordinary skill in the art, other drawings can also be obtained based on these drawings without involving any inventive effort.

The present invention will be further described below in conjunction with the drawings and embodiments.

FIG. 1 is a schematic diagram of the overall structure of the marking device of the present invention in the first angle of use.

FIG. 2 is a schematic diagram of the overall structure of the marking device of the present invention in the second angle of use.

FIG. 3 is a cross-sectional view of the marking device of the present invention in the state of use.

FIG. 4 is a schematic diagram of the overall structure of the marking device of the present invention in the state of storage.

FIG. 5 is the first partial exploded view of the marking device of the present invention.

FIG. 6 is the second partial exploded view of the marking device of the present invention.

FIG. 7 is a partial view of the handle part of the marking device of the present invention.

FIG. 8 is a partial view of the base part of the marking device of the present invention.

FIG. 9 is a partial cross-sectional view of the upper connector of the marking device of the present invention in the folded position.

FIG. 10 is a partial cross-sectional view of the upper connector of the marking device of the present invention in the usage position.

### DETAILED DESCRIPTION OF THE INVENTION

To make the objectives, features, and advantages of the present application clearer and more understandable, the specific implementation methods of the present application will be described in detail below with reference to the accompanying drawings. Many specific details are described in the following text to fully understand the present application. However, the present application can be implemented in many other ways that are different from those described here, and those of ordinary skill in the art can make similar improvements without departing from the scope of the present application. Therefore, the present application is not limited to the specific embodiments disclosed below.

In the description of the present application, the following terms should be understood as follows: If terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” are used, these terms indicate the orientation or positional relationships based on the orientation or positional relationships shown in the drawings. These terms are used only for the convenience of describing the present application and simplifying the description, and should not be understood as limiting the present application.

Furthermore, if terms such as “first” and “second” are used, these terms are used only for descriptive purposes and should not be understood as indicating or implying the relative importance or the number of technical features indicated. Therefore, features defined by “first” and “second” may explicitly or implicitly include at least one of these features. In the description of the present application, if the term “multiple” is used, it means at least two, such as two, three, etc., unless otherwise specified.

In the present application, unless otherwise clearly defined and limited, if terms such as “installation,” “connection,” “connection,” and “fixation” are used, these terms should be broadly understood. For example, they can be fixed connections, detachable connections, or integrated; they can be mechanical connections or electrical connections; they can be direct connections or indirect connections through intermediate media, or they can be the internal communication or interaction between two components, unless otherwise clearly defined. For ordinary technicians in this field, the specific meanings of the above terms in the present application can be understood according to specific situations.

In the present application, unless otherwise clearly defined and limited, if it is described that a first feature is “above” or “below” a second feature, it means that the first and second features can be in direct contact, or they can be in indirect contact through intermediate media. Moreover, “above,” “on top of,” and “over” can mean that the first feature is directly above or obliquely above the second feature, or it can simply mean that the first feature is at a higher horizontal level than the second feature. Similarly, “below,” “underneath,” and “beneath” can mean that the first feature is directly below or obliquely below the second feature, or it can simply mean that the first feature is at a lower horizontal level than the second feature.

It should be noted that if a component is described as being “fixed to” or “mounted on” another component, it can be directly on the other component, or there can be an intermediate component. If a component is described as being “connected to” another component, it can be directly connected to the other component, or there can be an intermediate component. If terms such as “vertical,” “horizontal,” “upper,” “lower,” “left,” “right,” and similar expressions are used, they are used for descriptive purposes and do not indicate the only possible implementations.

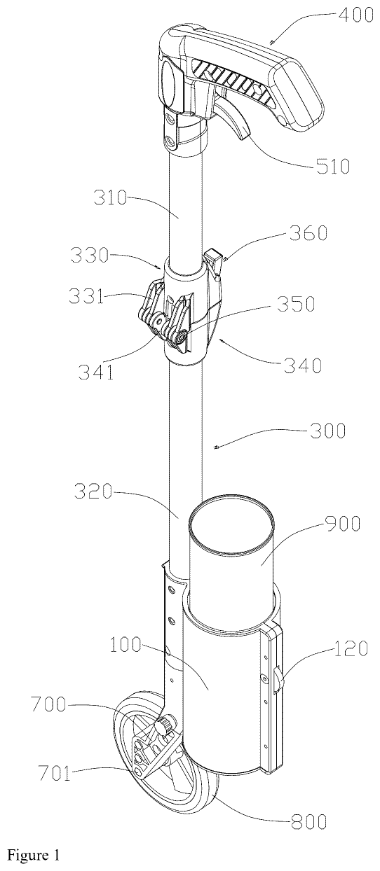

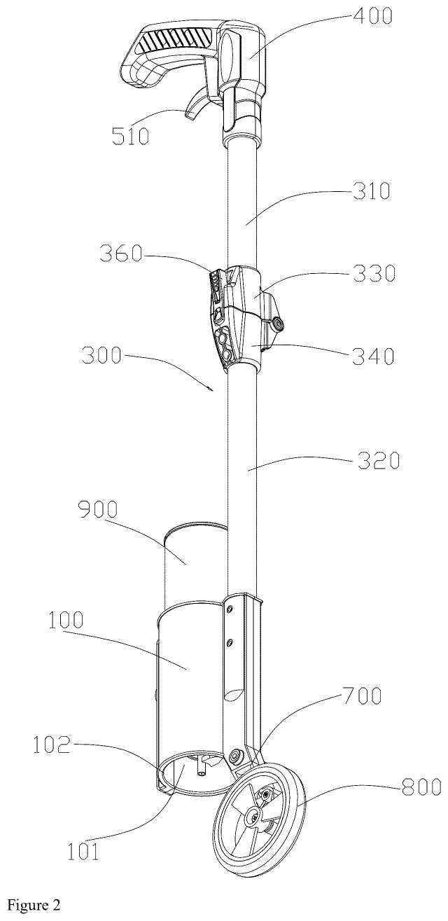

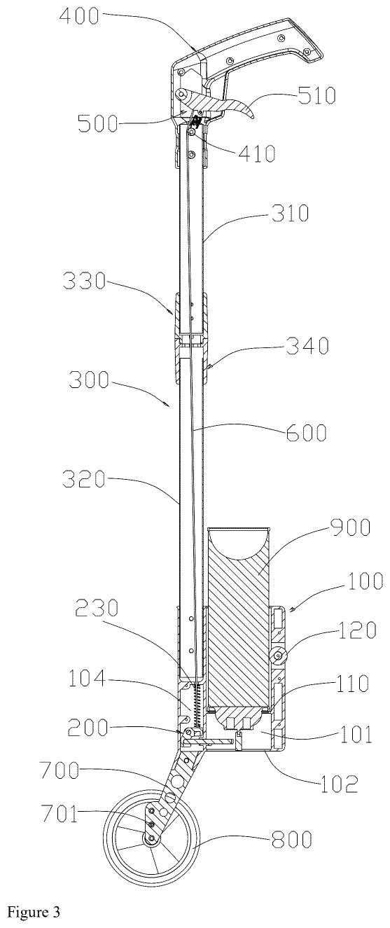

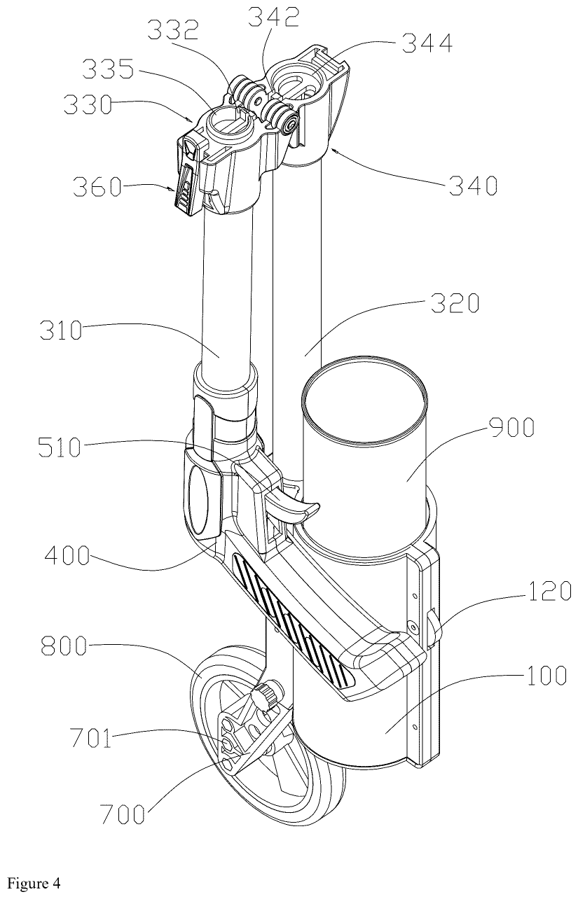

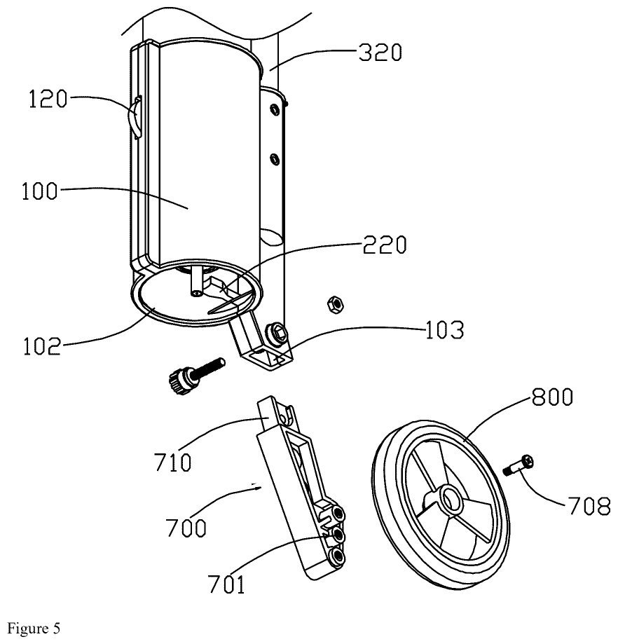

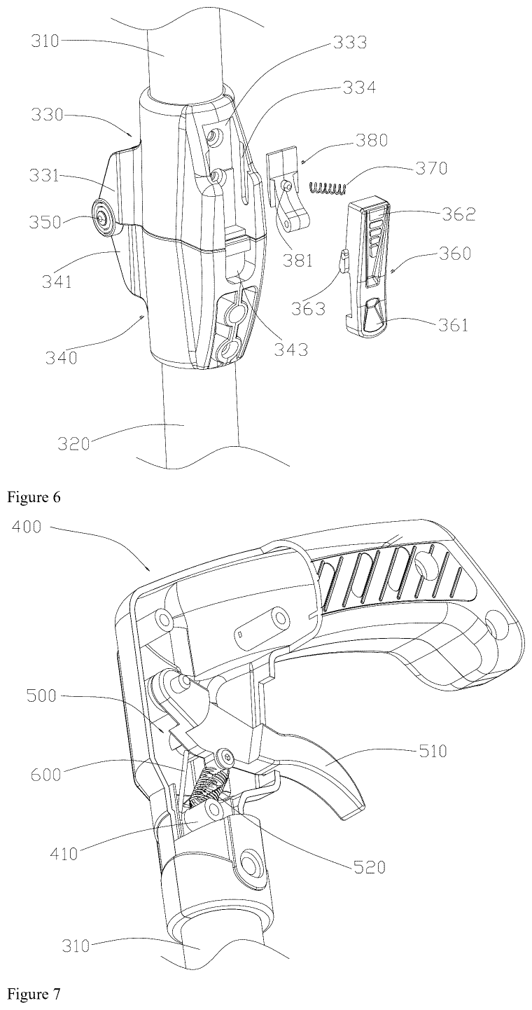

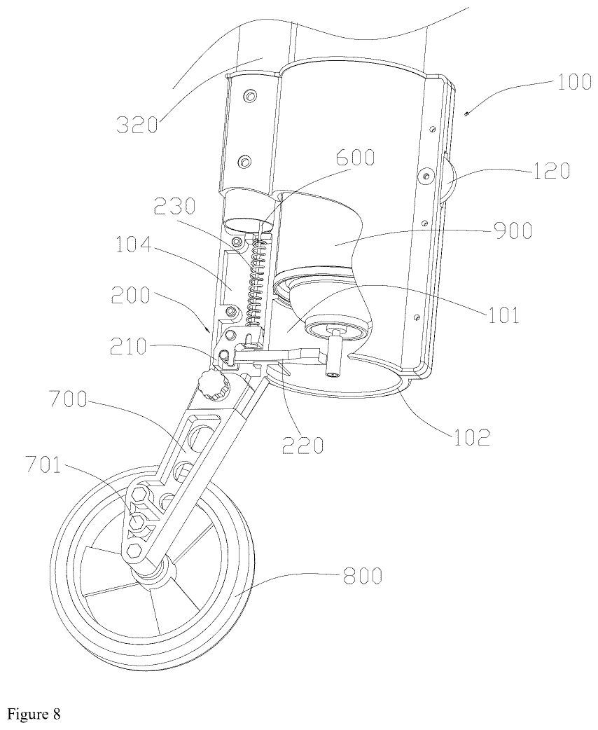

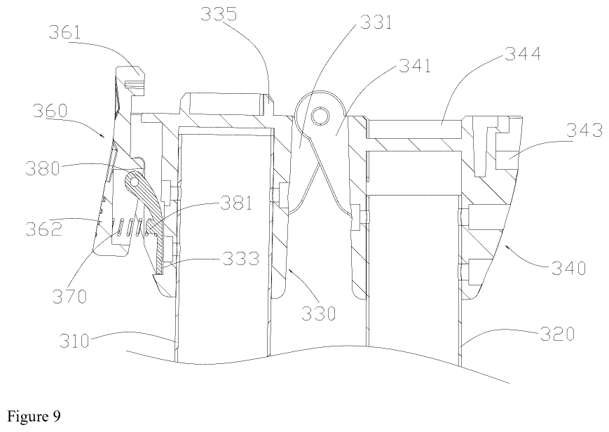

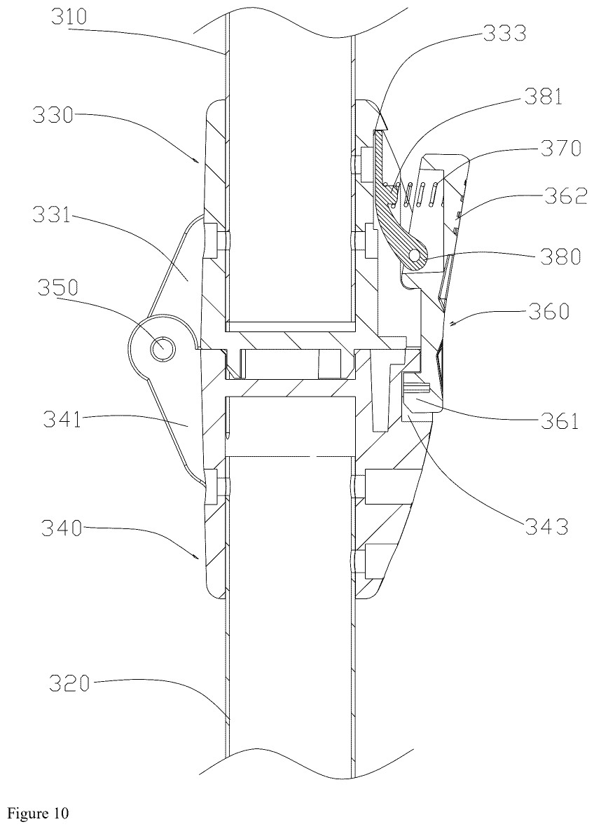

Referring to FIGS. 1 to 10, a foldable marking device includes:

A base (100) with an installation position, and an output component (200) mounted thereon. The installation position is configured to allow a spray can (900) to be installed. The output component (200) is configured to press the nozzle of the spray can (900) to release paint.

A connecting tube (300) comprising an upper tube section (310) and a lower tube section (320). The lower end of the lower tube section (320) is connected to the base (100). The lower end of the upper tube section (310) has an upper connector (330), and the upper end of the lower tube section (320) has a lower connector (340). The upper connector (330) is connected to the lower connector (340) and is rotatable between a folded position and a usage position.

A handle (400) connected to the upper end of the connecting tube (300). The handle (400) has an operating component (500) for user operation.

A connecting cord (600) with its upper end connected to the operating component (500) and its lower end connected to the output component (200). When the operating component (500) is pressed by the user, it drives the output component (200) to move via the connecting cord (600), thereby pressing the nozzle of the spray can (900).

With the above structure, when storing or transporting the product, the upper connector (330) is rotated to the folded position, where the upper tube section (310) and the lower tube section (320) are placed side by side. The flexible connecting cord (600) bends at the connection between the upper connector (330) and the lower connector (340), significantly reducing the length of the product for convenient storage and transportation. When using the product, the upper connector (330) is rotated to the usage position, where the upper tube section (310) and the lower tube section (320) are connected end-to-end to form the connecting tube (300). This allows the user to hold the handle and control the movement of the base (100) located at the lower end of the connecting tube (300). While moving the base (100), the user can press the operating component (500), which drives the connecting cord (600) and the output component (200) connected to the connecting cord (600). The output component (200) then presses the nozzle of the spray can (900), allowing paint to be sprayed out to form a marking line. The device is easy to use.

Preferably, the base (100) has an accommodating space (101) and a spray outlet (102) connected to the accommodating space (101). The spray can (900) is placed within the accommodating space (101), with its nozzle oriented towards the spray outlet (102). The paint sprayed from the spray can (900) exits through the spray outlet (102) and forms a marking line on the ground. Moreover, the connecting cord (600) is housed within the connecting tube (300), which effectively protects the connecting cord (600) from damage or interference from external debris, ensuring the stability of the product.

In this embodiment, the first side of the upper connector (330) is rotatably connected to the first side of the lower connector (340) via a rotating shaft (350). When the upper connector (330) is in the usage position, the second side of the upper connector (330) is detachably connected to the second side of the lower connector (340) through a latch (360) and a groove (343). With this structure, when using the product, the upper connector (330) is rotated to the usage position, and the latch (360) engages with the groove (343) to prevent relative rotation between the upper connector (330) and the lower connector (340). This allows the user to control the movement trajectory of the base (100) more accurately through the connecting tube (300), thereby creating the desired marking line. When storing the product, the latch (360) is disengaged from the groove (343), allowing the user to rotate the upper connector (330) to the folded position, reducing the product's size for convenient storage.

In this embodiment, the first side of the upper connector (330) has a protruding first shaft connection part (331), and the first side of the lower connector (340) has a protruding second shaft connection part (341). The first shaft connection part (331) and the second shaft connection part (341) are rotatably connected via the rotating shaft (350). With this structure, when the upper connector (330) is rotated to the folded position, the protruding first shaft connection part (331) and second shaft connection part (341) create a gap between the upper connector (330) and the lower connector (340), as well as between the upper tube section (310) and the lower tube section (320). This allows the upper tube section (310) and the lower tube section (320) to be placed side by side without the edges of the upper connector (330) squeezing the edges of the lower connector (340), which could otherwise restrict rotation.

In this embodiment, the side of the upper connector (330) near the first shaft connection part (331) has a first slot (332), and the side of the lower connector (340) near the second shaft connection part (341) has a second slot (342). When the upper connector (330) is in the folded position, at least part of the connecting cord (600) is inserted into the first slot (332) and the second slot (342). With this structure, as the upper connector (330) is rotated towards the folded position, the connecting cord (600) is inserted into the first slot (332) and the second slot (342). This prevents the connecting cord (600) from being stressed and inadvertently driving the output component (200) to press the nozzle of the spray can (900), which could cause paint to be sprayed out.

In this embodiment, the upper connector (330) has a latch (360) and the lower connector (340) has a groove (343). The latch (360) is detachably connected to the groove (343). When the latch (360) is disengaged from the groove (343), the upper connector (330) and the lower connector (340) can rotate around the rotating shaft (350). This structure allows the upper connector (330) and the lower connector (340) to be connected, preventing relative rotation between them when the latch (360) is engaged with the groove (343). When the latch (360) is disengaged, the upper connector (330) and the lower connector (340) can rotate around the rotating shaft (350), facilitating the folding and unfolding of the product by the user.

In this embodiment, the latch (360) has a latch end (361) and a pressing end (362). The middle part of the latch (360) is connected to the upper connector (330), with the latch end (361) and the pressing end (362) located on either side of the middle part of the latch (360). The latch (360) can rotate between a locking position and a release position to engage or disengage the latch end (361) from the groove (343). With this structure, pressing the pressing end (362) drives the latch end (361) to disengage from the groove (343), placing the latch (360) in the release position and unlocking it to allow relative rotation between the upper connector (330) and the lower connector (340). When the latch (360) is in the locking position, the latch end (361) engages with the groove (343), preventing relative rotation between the upper connector (330) and the lower connector (340).

In this embodiment, the upper connector (330) also has a first elastic element (370). The first end of the first elastic element (370) abuts against the outer surface of the upper connector (330), and the second end of the first elastic element (370) abuts against the inner surface of the pressing end (362) of the latch (360). This structure gives the latch (360) a tendency to move towards the locking position. When the user releases the pressing end (362), the elastic force of the first elastic element (370) drives the latch (360) towards the locking position, ensuring that the latch end (361) stably engages with the groove (343).

In this embodiment, the upper connector (330) has a latch base (380). The upper connector (330) also has a mounting groove (333) and a slide groove (334) on the side wall of the mounting groove (333). The middle part of the latch (360) has a sliding part (363). The sliding part (363) slides along the slide groove (334) to the end of the slide groove (334). The latch base (380) is inserted into the mounting groove (333), and the upper end of the latch base (380) is rotatably connected to the sliding part (363) via a rotating shaft. With this structure, during assembly, the sliding part (363) is connected to the latch base (380) using a rotating shaft. Then, the sliding part (363) is inserted along the slide groove (334) and slid to the end of the slide groove (334). The latch base (380) is inserted into the mounting groove (333), efficiently connecting the latch base (380) to the upper connector (330) and also connecting the latch base (380) to the latch (360).

In this embodiment, the side of the latch base (380) facing the latch (360) has a protrusion (381). The first end of the first elastic element (370) abuts against the surface of the latch (360) and is sleeved over the protrusion (381). With this structure, the first end of the first elastic element (370) abuts against the latch (360), which not only restricts the latch base (380) within the mounting groove (333) to enhance the stability of the product but also provides stable support for the first end of the first elastic element (370). This ensures that the elastic force of the first elastic element (370) can act on the pressing end (362), driving the latch (360) to rotate towards the locking position.

In this embodiment, the lower surface of the upper connector (330) has an insertion part (335), and the upper surface of the lower connector (340) has an insertion slot (344). When the upper connector (330) is in the usage position, the insertion part (335) is inserted into the insertion slot (344). This structure allows the upper connector (330) and the lower connector (340) to be coaxially connected more stably, preventing misalignment between the upper connector (330) and the lower connector (340). This ensures that when in the usage position, the latch (360) can accurately engage with the groove (343).

In this embodiment, the device also includes a wheel mounting part (700) and a wheel (800). The wheel mounting part (700) is detachably connected to the lower part of the base (100), and the wheel (800) is rotatably connected to the wheel mounting part (700). With this structure, during use, the user can connect the wheel mounting part (700) to the lower part of the base (100), then attach the wheel (800) to the base (100). By allowing the wheel (800) to contact the ground and pushing the device to move, the wheel (800) rotates synchronously. Adding the wheel (800) provides support and direction for the device, making it more convenient and efficient to use. The user can install or remove the wheel (800) according to the usage requirements.

In this embodiment, the lower part of the base (100) has an insertion hole (103), and the upper part of the wheel mounting part (700) has an insertion part (710). The insertion part (710) is inserted into the insertion hole (103). With this structure, during use, inserting the insertion part (710) into the insertion hole (103) connects the wheel mounting part (700) to the base (100), facilitating the installation of the wheel (800) by the user.

In this embodiment, the wheel mounting part (700) has multiple connecting holes (701), and the wheel (800) can be connected to any of the connecting holes (701) via a wheel axle (708). With this structure, when the wheel (800) is installed in different connecting holes (701), the distance between the spray outlet (102) and the ground varies. Consequently, the dispersion degree of the paint sprayed from the spray can (900) also differs, resulting in different widths of the marking line formed on the ground. During use, the user can install the wheel (800) in different connecting holes (701) according to the usage requirements to control the width of the marking line to be drawn.

In this embodiment, the operating component (500) includes a trigger (510) and a second elastic element (520). The trigger (510) is connected to the handle (400) and can rotate between a firing position and an unfired position. One end of the second elastic element (520) is connected to the handle (400), and the other end of the second elastic element (520) is connected to the trigger (510), giving the trigger (510) a tendency to move towards the unfired position. With this structure, during use, the user presses the trigger (510) with their finger, moving it to the firing position. At this time, the second elastic element (520) deforms and stores elastic potential energy. When the user releases the trigger (510), the second elastic element (520) returns to its original position, driving the trigger (510) to move towards the unfired position.

In this embodiment, the handle (400) has a positioning pin (410). One end of the second elastic element (520) is connected to the positioning pin (410), and the other end of the second elastic element (520) is connected to the middle part of the trigger (510). With this structure, one end of the second elastic element (520) can be conveniently and quickly hung on the positioning pin (410). The other end of the second elastic element (520) can be connected to the middle part of the trigger (510) through a hook or a pressing screw, thereby achieving the connection between the second elastic element (520) and the handle (400) and the trigger.

In this embodiment, the output component (200) includes a transmission part (210) and a pressing part (220). The transmission part (210) is connected to the base (100) and can rotate between a pressing position and a release position. The base (100) has a through hole communicating with the accommodating space (101). The first end of the pressing part (220) is rotatably connected to the transmission part (210), and the second end of the pressing part (220) extends through the through hole into the accommodating space (101) to press the nozzle of the spray can (900). With this structure, during use, the user operates the operating component (500) to pull the connecting cord (600), which drives the transmission part (210) to rotate from the release position to the pressing position. The transmission part (210) then drives the pressing part (220) to move, causing the second end of the pressing part (220) to press the nozzle of the spray can (900), allowing paint to be sprayed out.

In this embodiment, the output component (200) also includes a third elastic element (230). The first end of the third elastic element (230) is connected to the base (100), and the second end of the third elastic element (230) is connected to the transmission part (210), giving the transmission part (210) a tendency to move towards the release position. With this structure, the third elastic element (230) drives the transmission part (210) to rotate from the pressing position to the release position, bringing the pressing part (220) back to its original position. This allows the output component (200) to automatically reset after the user releases the operating component (500), stopping the spray can (900) from spraying paint.

In this embodiment, the base (100) has a spring housing cavity (104). The third elastic element (230) is located within the spring housing cavity (104) and is sleeved over the connecting cord (600). The first end of the third elastic element (230) abuts against the upper inner wall of the spring housing cavity (104), and the second end of the third elastic element (230) abuts against the upper surface of the transmission part (210). With this structure, the spring housing cavity (104) can accommodate the third elastic element (230), protecting it from damage and ensuring the stability of the product.

In this embodiment, the base (100) has a positioning block (110) protruding towards the accommodating space (101). The positioning block (110) is used to abut against the upper edge of the spray can (900). With this structure, during use, the spray can (900) is inserted into the accommodating space (101) until its upper edge abuts against the positioning block (110). At this point, the nozzle of the spray can (900) is precisely aligned with the pressing part (220). The positioning block (110) not only restricts the insertion depth of the spray can (900) but also ensures the correct position of the nozzle.

In this embodiment, the base (100) also has a guide wheel (120), at least part of which extends through the inner wall of the accommodating space (101) into the accommodating space (101). With this structure, when inserting the spray can into the accommodating space (101), the surface of the guide wheel (120) contacts the surface of the spray can, providing guidance and positioning. This makes it easier for the user to insert the spray can. Moreover, the guide wheel (120), which is usually elastic, can hold the spray can in place, preventing it from shaking and improving the stability of the spray can within the accommodating space (101).

1. A foldable marking device, characterized in that it comprises the following components:
A base (100), the base (100) having an installation position, and an output component (200) provided on the base (100), the installation position being configured to allow a spray can to be installed, and the output component (200) being configured to press the nozzle of the spray can to release paint from the spray can;
A connecting tube (300), the connecting tube (300) including an upper tube section (310) and a lower tube section (320), the lower end of the lower tube section (320) being connected to the base (100), the lower end of the upper tube section (310) having an upper connector (330), the upper end of the lower tube section (320) having a lower connector (340), the upper connector (330) being connected to the lower connector (340) and being rotatable between a folded position and a usage position;
A handle (400), the handle (400) being connected to the upper end of the connecting tube (300), the handle (400) having an operating component (500), the operating component (500) being configured for user pressing;
A connecting cord (600), the upper end of the connecting cord (600) being connected to the operating component (500), the lower end of the connecting cord (600) being connected to the output component (200), when the operating component (500) is pressed by the user, the operating component (500) drives the output component (200) to move via the connecting cord (600), thereby causing the output component (200) to press the nozzle of the spray can.

2. The foldable marking device according to claim 1, characterized in that the first side of the upper connector (330) is rotatably connected to the first side of the lower connector (340) via a rotating shaft (350), and when the upper connector (330) is in the usage position, the second side of the upper connector (330) is detachably connected to the second side of the lower connector (340) through the cooperation of a latch (360) and a groove (343).

3. The foldable marking device according to claim 2, characterized in that the first side of the upper connector (330) has a first protruding first shaft connection part (331), and the first side of the lower connector (340) has a second protruding second shaft connection part (341), the first shaft connection part (331) and the second shaft connection part (341) being rotatably connected via the rotating shaft (350).

4. The foldable marking device according to claim 3, characterized in that the side of the upper connector (330) close to the first shaft connection part (331) has a first slot (332), and the side of the lower connector (340) close to the second shaft connection part (341) has a second slot (342), when the upper connector (330) is in the folded position, at least part of the connecting cord (600) is inserted into the first slot (332) and the second slot (342).

5. The foldable marking device according to claim 2, characterized in that the latch (360) is provided on the upper connector (330), and the groove (343) is provided on the lower connector (340), the latch (360) being detachably connected to the groove (343), when the latch (360) is detached from the groove (343), the upper connector (330) and the lower connector (340) rotate around the rotating shaft (350).

6. The foldable marking device according to claim 5, characterized in that the latch (360) has a latch end (361) and a pressing end (362), the latch (360) is connected to the upper connector (330) in the middle, the latch end (361) and the pressing end (362) are located on either side of the middle of the latch (360), the latch (360) rotates between a locking position and a release position, so that the latch end (361) is latched or detached from the groove (343).

7. The foldable marking device according to claim 6, characterized in that the upper connector (330) also has a first elastic element (370), the first end of the first elastic element (370) abuts against the outer surface of the upper connector (330), the second end of the first elastic element (370) abuts against the inner surface of the pressing end (362) of the latch (360), so that the latch (360) has a tendency to move towards the locking position.

8. The foldable marking device according to claim 7, characterized in that the upper connector (330) has a latch base (380), the upper connector (330) has a mounting groove (333) and a slide groove (334) provided on the side wall of the mounting groove (333), the middle of the latch (360) has a sliding part (363), the sliding part (363) slides along the slide groove (334) to the end of the slide groove (334), the latch base (380) is inserted into the mounting groove (333), the upper end of the latch base (380) is rotatably connected to the sliding part (363) via a rotating shaft.

9. The foldable marking device according to claim 8, characterized in that the side of the latch base (380) facing the latch (360) has a protrusion (381), the first end of the first elastic element (370) abuts against the surface of the latch (360) and is sleeved on the protrusion (381).

10. The foldable marking device according to claim 2, characterized in that the lower surface of the upper connector (330) has an insertion part (335), and the upper surface of the lower connector (340) has an insertion slot (344), when the upper connector (330) is in the usage position, the insertion part (335) is inserted into the insertion slot (344).

11. The foldable marking device according to claim 1, characterized in that it further comprises a wheel mounting part (700) and a wheel (800), the wheel mounting part (700) being detachably connected to the lower part of the base (100), the wheel (800) being rotatably connected to the wheel mounting part (700).

12. The foldable marking device according to claim 11, characterized in that the lower part of the base (100) has an insertion hole (103), and the upper part of the wheel mounting part (700) has an insertion part (710), the insertion part (710) being inserted into the insertion hole (103).

13. The foldable marking device according to claim 11, characterized in that the wheel mounting part (700) has a plurality of connecting holes (701), the wheel (800) being connectable to any one of the connecting holes (701) via a wheel axle (708).

14. The foldable marking device according to claim 1, characterized in that the operating component (500) includes a trigger (510) and a second elastic element (520), the trigger (510) being connected to the handle (400) and rotating between a firing position and an unfired position, one end of the second elastic element (520) being connected to the handle (400), the other end of the second elastic element (520) being connected to the trigger (510) and causing the trigger (510) to have a tendency to move towards the unfired position.

15. The foldable marking device according to claim 14, characterized in that the handle (400) has a positioning pin (410), one end of the second elastic element (520) being connected to the positioning pin (410), the other end of the second elastic element (520) being connected to the middle of the trigger (510).

16. The foldable marking device according to claim 1, characterized in that the output component (200) includes a transmission part (210) and a pressing part (220), the transmission part (210) being connected to the base (100) and rotating between a pressing position and a release position, the base (100) having a through hole communicating with the accommodating space (101), the first end of the pressing part (220) being rotatably connected to the transmission part (210), the second end of the pressing part (220) extending through the through hole into the accommodating space (101), the second end of the pressing part (220) being configured to press the nozzle of the spray can.

17. The foldable marking device according to claim 16, characterized in that the output component (200) further includes a third elastic element (230), the first end of the third elastic element (230) being connected to the base (100), the second end of the third elastic element (230) being connected to the transmission part (210), so that the transmission part (210) has a tendency to move towards the release position.

18. The foldable marking device according to claim 17, characterized in that the base (100) has a spring housing cavity (104), the third elastic element (230) being provided in the spring housing cavity (104) and sleeved on the connecting cord (600), the first end of the third elastic element (230) abutting against the upper inner wall of the spring housing cavity (104), the second end of the third elastic element (230) abutting against the upper surface of the transmission part (210).

19. The foldable marking device according to claim 1, characterized in that the base (100) has a positioning block (110) protruding towards the accommodating space (101), the positioning block (110) being configured to abut against the upper edge of the spray can.

20. The foldable marking device according to claim 1, characterized in that the base (100) also has a guide wheel (120), at least part of the guide wheel (120) extending through the inner wall of the accommodating space (101) into the accommodating space (101).
